(19) United States
(12) Patent Application Publication
(10) Pub. No.: US 2008/0141799 A1
(43) Pub. Date: Jun. 19, 2008

(54) DUAL GEAR PUMP TRANSMISSION

(76) Inventors: Douglas W. Seitz, Eau Claire, WI (US); Michael C. Ruthy, Chippewa Falls, WI (US)

Correspondence Address: ANTHONY J. BOURGET, P.O. BOX 81, EAU CLAIRE, WI, 54702-0081, US

(21) Appl. No.: 11/956,717

(22) Filed: Dec. 14, 2007

Related U.S. Application Data
(60) Provisional application No. 60/870,086, filed on Dec. 14, 2006.

(51) Int. Cl. F16H 37/00

(52) U.S. Cl. 74/15.2

(57) ABSTRACT

A firefighting pump transmission for use with an emergency vehicle pump comprising a PTO gear affixed to a drive shaft of the transmission and an impeller clutch driving gear affixed to the drive shaft adjacent the PTO gear. The clutch driving gear may couple with a multi-disk clutch to turn an impeller shaft. The transmission allows for changing the gearing of the PTO without affecting the ratio or speeds of the impeller driving mechanism, and vice versa. The dual gears on the drive shaft accommodate compatibility with a Commercially Available PTO device to be mounted to the housing of the transmission to power a variety of devices.

### CROSS-REFERENCE TO RELATED APPLICATIONS

Applicant claims priority based on Provisional Patent Application No. 60/870,086, filed Dec. 14, 2006, the entirety of which is incorporated herein by reference.

### DESCRIPTION

### Background of the Invention

1. Field of the Invention

The present invention relates generally to transmissions capable of powering multiple devices from a single drive shaft, and more specifically to pumps and pump transmissions capable of powering an impeller shaft of a fluid pump and at least another device, and particularly to emergency vehicle pumps and transmissions of such variety.

2. Background information

Transmissions capable of powering a primary device and at least another device are not new. Some transmissions, especially in the automotive or truck areas, include a drive for powering a primary device, such as an axle of the vehicle, and may also include a power take-off, commonly known as a PTO. A PTO device is designed to power an auxiliary device, drawing power from the main drive of the transmission. In some instances an auxiliary device itself might take power off from (or directly connect to) the main transmission, as opposed to coupling with an intermediate PTO device. A PTO device typically attaches to the main transmission and in turn powers an auxiliary device. Typically a transmission includes an internal gear, i.e., a “PTO gear”, to which the auxiliary device or to which the PTO device couples in order for the auxiliary device or the PTO device to be driven.

Pump transmissions, including pump transmissions of the fire-fighting variety have also been designed to power a primary device such as a pump, and at least another device, such as a booster pump or a compressor. One such system includes extending the impeller shaft out the opposite side of the gearbox of a pump transmission. One end of the impeller shaft is engaged with the pump impeller while the opposite end is available for use to power another device. In other systems, an additional gear may be included inside the gearcase to provide a power output. An example of such additional gearing is found in the patent to Hoffman, U.S. Pat. No. 4,587,862, issued May 13, 1986. In Hoffman, an input member 30 alternately powers an output member 32 or a pump shaft 18 by means of a sliding gear 70. A further example of a system that provides additional gearing is found in the patent to Eberhardt, U.S. Pat. No. 5,145,014, where the transmission powers a rotating pump shaft 18 and an air compressor 13.

In other firefighting pump transmission systems an opening is provided on the gearcase or housing of a primary transmission to receive a specially designed auxiliary transmission or device. A specially designed PTO device is used to couple the primary transmission to the auxiliary device. The auxiliary system may be equipped with a sliding clutch gear to engage or disengage a driven device. For instance, an auxiliary device such as a booster pump or compressor may typically be mounted to the housing or closely coupled to the housing of a firefighting pump transmission. An example of such a system is the model LDMH pump manufactured by W.S. Darley & Company, Chippewa Falls, Wis.

### SUMMARY

While the prior pump transmissions power a primary device and also allow for the powering of an auxiliary device or devices, they are limited in their versatility or to the types of auxiliary devices that may be powered, or require special effort to configure the transmission to accommodate use of a PTO device and especially use of Commercially Available PTO devices.

In some instances it is desired to change the gearing used for driving the impeller shaft of a firefighting pump. Changing the impeller shaft gearing typically affects the ratios associated with the PTO gearing. If the impeller shaft gearing is changed but the PTO gearing is not, the speeds or ratios pertaining to the PTO gearing will be varied. Varying of the speeds or ratios of the PTO may not be desired. Thus, changing the impeller shaft gearing often requires changing the gearing associated with the PTO device, or at least requires efforts to adjust the gearing of the PTO device in order to maintain acceptable speeds or ratios for powering an auxiliary device coupled to the PTO device. Some efforts used to change the speeds or ratios, short of changing out the entire gearing, include use of spacers or other methods that are troublesome or result in a cobbled-together design. In some instances the changed ratios may be acceptable for use with a particular accessory device, while in other instances a different accessory device must be used, or the PTO gearing must be modified or completely changed in order to accommodate the ratio change due to the change of impeller gearing.

Additionally, in some instances it may be desired to change an auxiliary device or the PTO gearing used for driving the auxiliary device. Such change in turn may require an adaptation or complete change of the impeller shaft gearing so as to maintain acceptable speeds and ratios for driving the pump.

In either case, swapping out or changing the gearing of the impeller shaft often requires swapping-out or changing the gearing of the PTO, and vice versa. This has not been viewed so much as a problem but, rather, a fact of life or a necessary aspect of such transmissions.

The present inventors have recognized, however, that being able to swap-out or modify the PTO gearing while not having to swap-out or modify the impeller gearing, and vice versa, would provide numerous benefits, such as providing the flexibility of varying the rotational speeds and ratios of the transmission components, including the ability to change the ratios of the PTO gearing without having to change the ratios of the impeller gearing (and vice versa), the ability to select from a variety of PTO devices and auxiliary devices without having to modify or swap-out the impeller shaft gearing (and vice versa), the ability to power devices not normally used in conjunction with a pump transmission or to more easily accommodate use of such devices, and, among other benefits, to accommodate use of Commercially Available PTO devices (defined below) in conjunction with such transmissions. Use of Commercially Available PTO devices in turn allows for use of a greater variety of auxiliary devices and allows for such devices to be remotely coupled with a drive-line, for instance, among other benefits.

In accordance with the invention, then, the problem of eliminating the need to modify or swap-out the gearing of a PTO device due to changes made to the gearing which drives an impeller shaft of a firefighting pump, and vice versa, is solved by placing two gears on the input shaft of the pump transmission where one of the gears drives the PTO device and the other gear operates to independently drive the impeller shaft. Such arrangement allows for the PTO gearing to be designed with greater independence from the impeller gearing so that different speeds or ratios may be achieved (i.e., changes of the gear ratio for the pump will not impact changes in the gear ratio for the PTO, and vice versa). Further, such arrangement allows for driving a variety of devices that may have different gear pitches or other angles or other features that would otherwise be incompatible with the impeller gearing or require changes or modification to the mechanisms powering the impeller shaft. Further, such arrangement allows for greater compatibility with various auxiliary devices (including compatibility with Commercially Available PTO devices).

In particular embodiments of the inventions an impeller clutch driving gear is affixed to the drive shaft and a PTO gear is affixed to the drive shaft adjacent the impeller clutch driving gear. In preferred aspects, a multi-disk clutch is mounted on the impeller shaft with the clutch drawing power from the input shaft. In a particular embodiment the impeller clutch driving gear couples with a clutch, preferably a multi-disk clutch. Also in a particular embodiment the PTO gear is a spur gear. Advantageously, an access port is positioned adjacent the PTO gear and the clutch driving gear and is configured to receive a Commercially Available PTO.

Further optional aspects include mounting a PTO device to the transmission and coupling the PTO device with a drive-line to power a remote auxiliary device.

The above summary of the present invention is not intended to describe each illustrated embodiment or every implementation or aspect of the present invention. The figures and detailed description that follow more particularly exemplify these embodiments.

### BRIEF DESCRIPTION OF THE DRAWINGS

FIG. 1 is a perspective view of a firefighting pump transmission embodying the principles of the present invention.

FIG. 2 is a further perspective view of the transmission of FIG. 1 having portions removed for clarity.

FIG. 3 is a further perspective view of the transmission of FIG. 1 having portions removed for clarity.

FIG. 4 is a section view taken along line 4-4 of FIG. 1.

FIG. 5 is a perspective view of the transmission of FIG. 1 equipped with a pump and having plate removed.

FIG. 6 is a partial perspective exploded view of a pump transmission embodying the principles of the present invention.

FIG. 7 is an exploded perspective view of the transmission of FIG. 1.

FIG. 8 is a bottom perspective view of a PTO device known in the prior art.

FIG. 9 is a perspective view of a pump and transmission and PTO device embodying the principles of the present invention.

FIG. 10 is a perspective view of a pump and transmission having a PTO device embodying the principles of the present invention and where a portion of the housing is removed for illustration.

FIG. 11 depicts a type of pump and pump transmission known in the prior art.

While the invention is amenable to various modifications and alternative forms, specifics thereof have been shown by way of example in the drawings and will be described in detail. It should be understood, however, that the intention is not necessarily to limit the invention to the particular embodiments or aspects described. On the contrary, the intention is to cover all modifications, equivalents, and alternatives falling within the spirit and scope of the invention and as defined by the appended claims.

### DETAILED DESCRIPTION

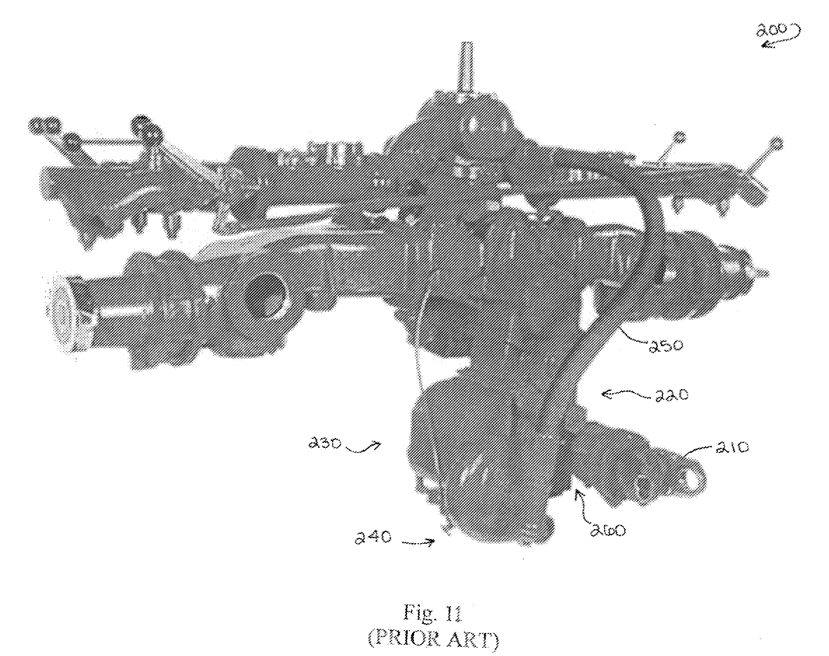

Among the pumps and pump transmissions known in the prior art are those referenced above in the background section and the device shown in FIG. 11. The FIG. 11 device shows a back-side view of pump/pump transmission 200. An input shaft (which is a shaft positioned opposite output shaft 210) enters the housing of the transmission 220 at a front portion of the transmission 220. An auxiliary transmission 230 is mounted to the side of the transmission 220. The auxiliary transmission 230 powers a smaller pump 240 which is fed by a hose 250. In this prior system, pump 240 operates as a booster for the pump/pump transmission 200, achieving higher pressures than the pump 200 would otherwise achieve.

The auxiliary transmission 230 is equipped with a sliding clutch gear (not shown) to engage or disengage the PTO driven device 240. In the illustrated case, the driven device (auxiliary) is the smaller pump 240. The PTO driven device 240 might alternatively be a compressor. The transmission 230 is a two-gear transmission that mounts to the side of main transmission 220 and operates as a power-take-off PTO device.

Within the housing 260 of pump/pump transmission 200, a “PTO transmission gear” (not shown) of transmission 230 couples with a “drive gear” that is mounted on input shaft 210. The drive gear powers both PTO device 230 and an idler gear which in turn powers a third gear within housing 260 to power the impeller shaft of pump and transmission 200. As the drive gear turns, both the PTO device 230 and the main impeller shaft within housing 260 are powered. There are also other known types of firefighting pump transmissions that use a PTO to power an auxiliary device where the PTO is powered together with the impeller shaft.

In designing the pump/pump transmission 200, a number of specialized changes or accommodations were and are typically required in order to assure that an auxiliary device may be utilized. For instance, the gear ratio of the PTO transmission gear and the drive gear are not always compatible, thus requiring the use of spacers to be placed between the PTO transmission gear and drive gear. The pitch of the PTO transmission gear must also match the pitch of the drive gear, which may be of a helical variety. Further, the opening size on the housing and the bolt patterns of the PTO device must match. Further, the number of the respective gears must be considered in order to assure appropriate speeds, and additional or different gears may be needed to adjust the speeds properly. Further, the PTO device would necessarily run simultaneously with the drive gear unless a separate clutch is included within the PTO device. In cases where the PTO device is to be changed, and thus requiring a different PTO transmission gear, a corresponding change to the drive gear or other elements of the transmission 200 may be required. Indeed, a Commercially Available PTO device could not be used in conjunction with such transmission, or other known transmissions, or even if changes could be made to accommodate such use, the benefits of doing so, in light of the required ratio disparities and requirement to modify or change gears which drive the impeller shaft makes such changes impractical. Further, if the impeller shaft gears or drive gear is changed, a change of the PTO transmission gear or auxiliary device may be required due to the varying ratios and speeds.

The known firefighting pump transmissions lack versatility because in order to accommodate changes in the ratios and speeds due to making changes of the impeller gearing, a change to the PTO gearing, and vice versa, may be required. As noted above, it remained for the present inventors to recognize that being able to swap-out or modify the PTO gearing while not having to swap-out or modify the impeller gearing, and vice versa, would provide numerous benefits, as detailed hereinabove. Indeed, the transmissions referenced in the background and in FIG. 11 may power an auxiliary device, yet such transmissions are limited as compared to the present invention.

In accordance with the invention, the problem of eliminating the need to modify or swap-out the gearing of a PTO device due to changes made to the gearing which drives an impeller shaft of a firefighting pump, and vice versa, is solved by placing two gears on the input shaft of the pump transmission where one of the gears drives the PTO device and the other gear operates to independently drive the impeller shaft. The present inventors have discovered that such arrangement allows for the PTO gearing to be designed with greater independence from the impeller gearing so that the speeds and other features of the PTO gear may be compatible with auxiliary devices (including compatibility with Commercially Available PTO devices). Indeed, the arrangement allows for the PTO gearing or a PTO device to be swapped-out from the transmission without affecting the speeds or ratios of the impeller shaft gearing, and vice versa.

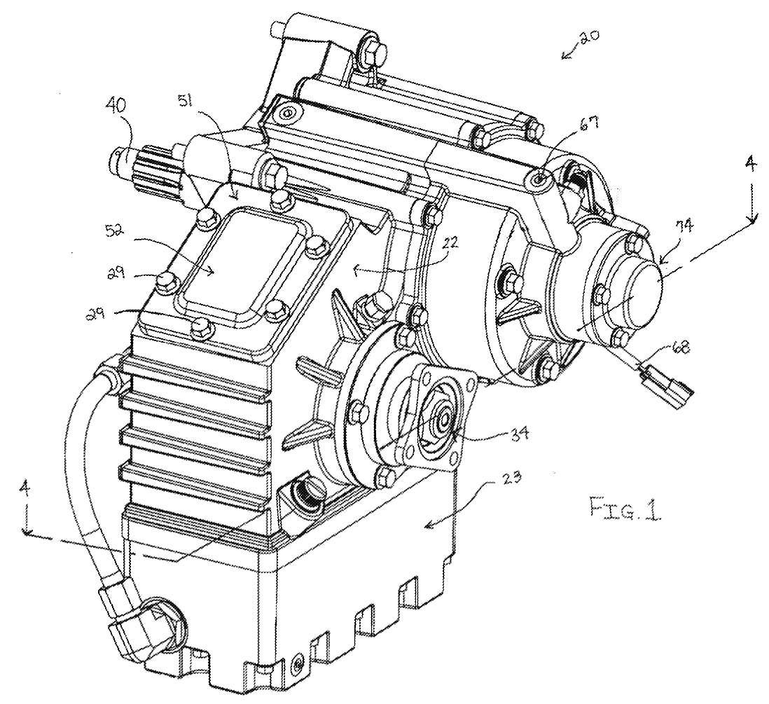

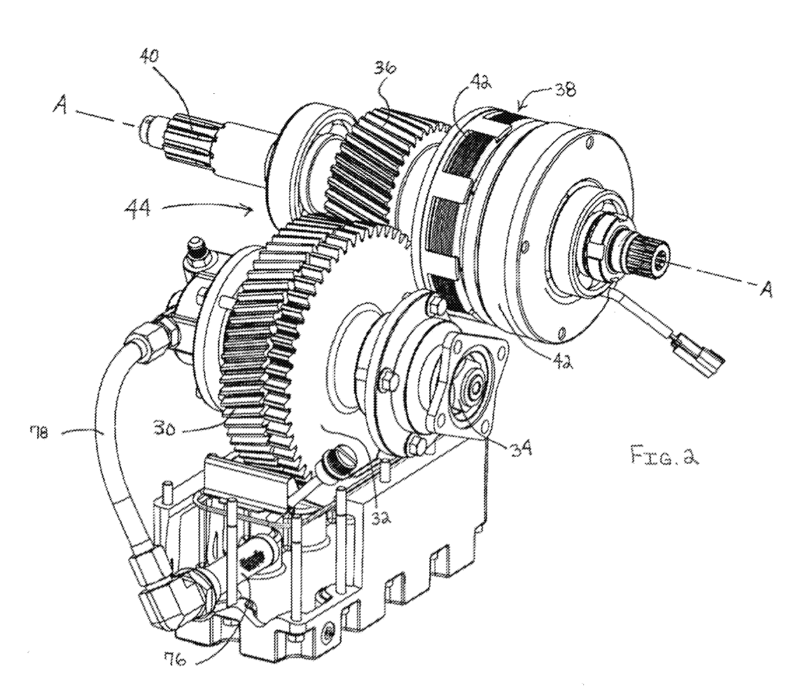

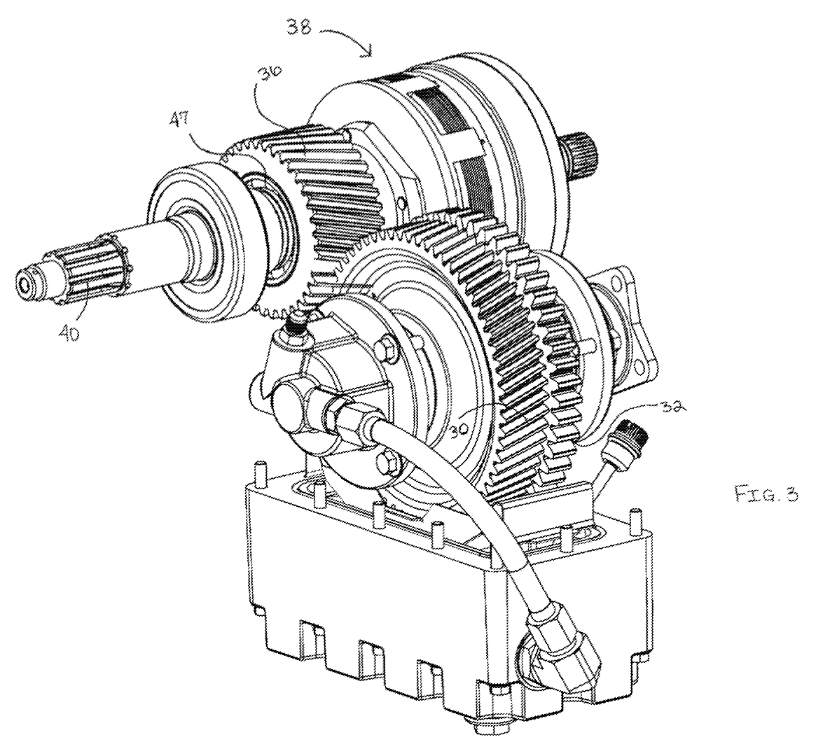

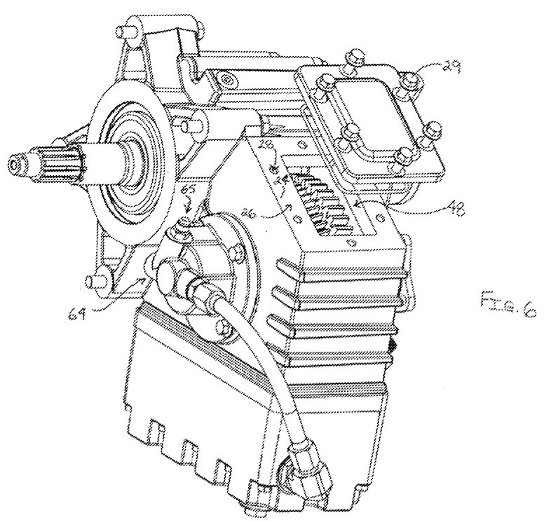

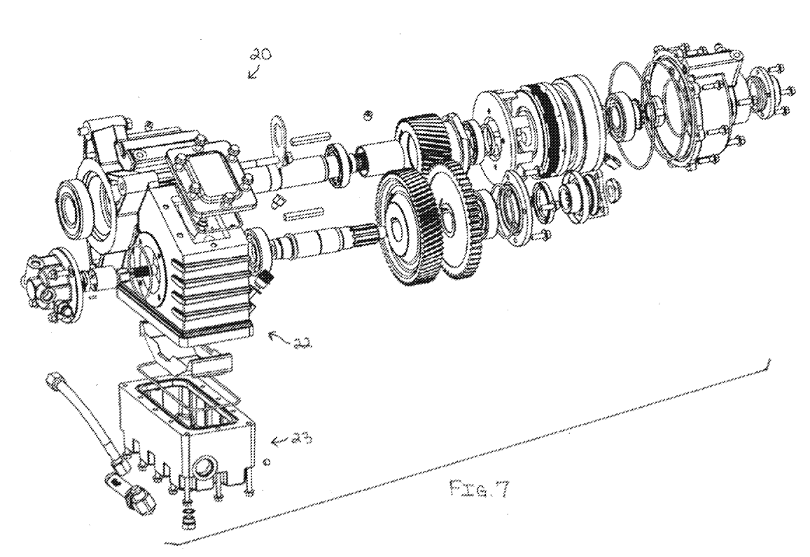

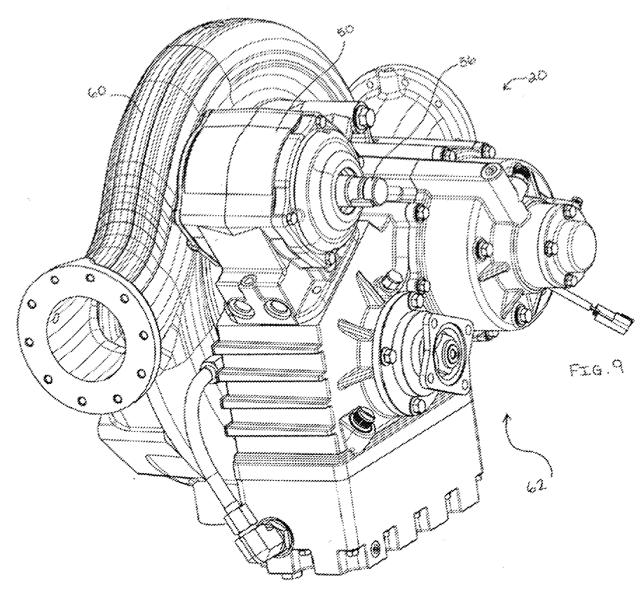

Referring to FIGS. 1-10, a transmission embodying the principles of the present invention is generally depicted with reference to numeral 20. In one aspect, transmission 20 is a fluid pump transmission and includes a housing 22. Transmission 20 operates with a pump of a firefighting variety and may be used on a firetruck or other emergency response vehicle. Housing 22 is preferably made from cast metal such as iron, preferably aluminum. Housing 22 is a single-piece construction and may attach to or include a bottom 23. Housing 22 receives a drive shaft 34 which enters housing 22 in conventional fashion. Drive shaft 34 connects to a clutch driving gear 30 within housing 22 (See FIGS. 2-4). Clutch driving gear 30 is operatively coupled to an impeller shaft 40. Transmission 20 further includes a PTO gear 32 affixed to drive shaft 34. In accordance with the invention, the versatility of firefighting pump transmission 20 is enhanced by affixing to drive shaft 34 the clutch driving gear 30 which operates to independently drive impeller shaft 40. Clutch driving gear 30 operates to power impeller shaft 40 independently from operation of PTO gear 32. In one particular aspect, impeller shaft 40 is selectively powered by means of a clutch, such as clutch 38. While drive shaft 34 and gears 32 and 30 may rotate together, clutch 38 allows for impeller shaft 40 to independently remain idle. When clutch 38 is activated, impeller shaft 40 rotates.

Preferably clutch 38 couples clutch driving gear 30 with impeller shaft 40. Clutch 38 includes a clutch gear 36. Clutch driving gear 30 engages with clutch gear 36. While other varieties may be used, preferably clutch driving gear 30 is a helical gear matched to a corresponding helical gear 36. Together clutch driving gear 30 and clutch gear 36 form a pump gear set 44 (See FIG. 2). The number of teeth used on gear set 44 may be altered to achieve a desired drive shaft-to-impeller shaft ratio. Gear set 44 may include multiple gears, however use of a pair of gears such as gear 30 and clutch gear 36 is preferred. It may be appreciated that the particular gear set 44 may be established to have a rotational output speed which matches an optimal impeller rotation speed of a given pump 60 which may be engaged with impeller shaft 40.

As drive shaft 34 spins, clutch driving gear 30 spins which in turn spins clutch gear 36 to operate impeller shaft 40 when clutch 38 is activated. When clutch 38 is deactivated, clutch gear 36 spins freely upon shaft 40 and rides on bearings 47. Clutch 38 is preferably of a well known multi-disk variety having disk plates 42. Clutch 38 includes a chuck portion 43 which is securely mounted to impeller shaft 40. As the clutch gear 36 spins, so do some of the plates 42. When clutch 38 is activated, plates 42 bind upon or within chuck 38, thereby causing chuck 38 and impeller shaft 40 to turn. The speed of rotation of impeller shaft 40 is dependent in part on the speed of rotation of drive shaft 34 and the gearing ratio of gear set 44. It may be appreciated that the speed of rotation of impeller 40 may be different from the speed of rotation of drive shaft 34.

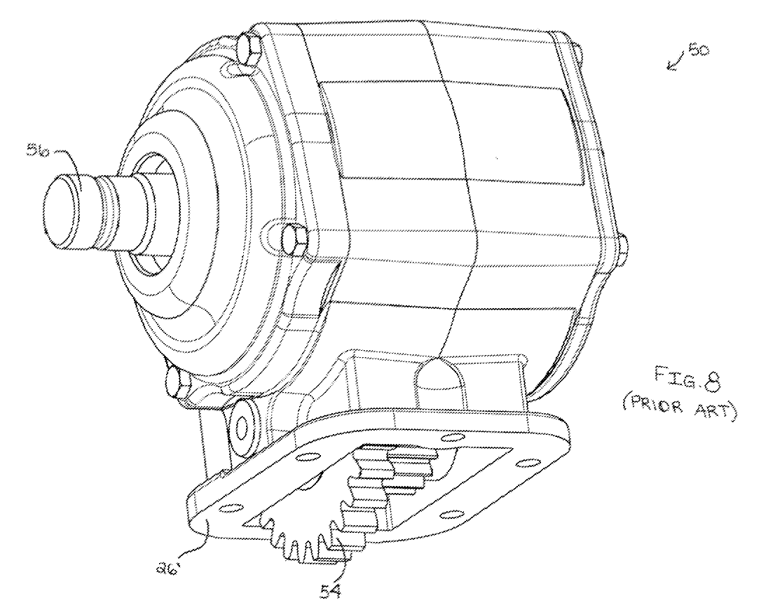

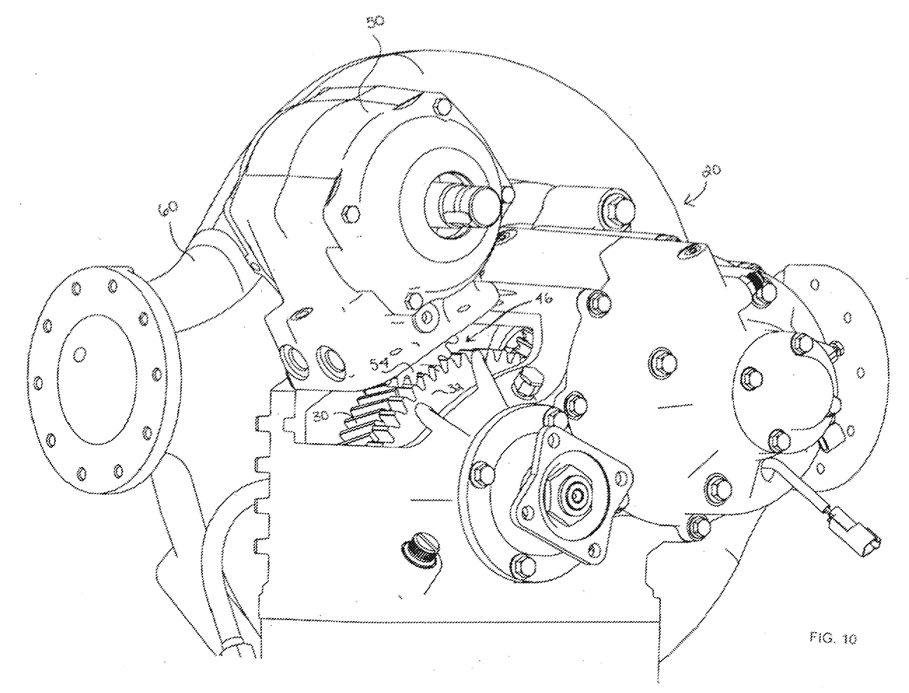

As referenced above, transmission 20 includes a PTO gear 32 affixed to drive shaft 34. PTO gear 32 is affixed to shaft 34 so that it rotates as shaft 34 spins, and further preferably does not slide along shaft 34 but remains in a set position. While other varieties may be used, preferably PTO gear 32 is of a spur gear variety and is positioned within housing 22. PTO gear 32 allows for gearing the pump 60 and the PTO device 50 (See FIGS. 8-10) independently. More preferably, PTO gear 32 is configured to engage with a Commercially Available power take-off, or PTO 50. A “Commercially Available” PTO device is one that mounts to a standard PTO opening of a casing, particularly such devices that mount to openings having a six or eight bolt pattern as defined under Society of Automotive Engineers Standard SAE J704, as well as openings having a ten bolt pattern for mounting on an Allison transmissions. One non-limiting example of a PTO gear 32 for use in conjunction with the invention includes a spur gear 32 which matches to fit a receiving gear 54 (See FIG. 8) of PTO 50 where the PTO receiving gear 54 is also a spur gear. It may be appreciated that gear 32 may be configured to match other types of receiver gears, yet is preferably configured to operate with Commercially Available PTO devices. Other non-limiting examples of Commercially Available PTO 50 devices that may be used with the invention include Chelsea and Muncie (not shown) varieties. Together, gear 32 and receiver gear 54 form a PTO gear set 46 (See FIG. 10). The number of teeth used on gear set 46 may be altered to achieve a desired drive shaft-to-PTO output shaft ratio. Gear set 46 may include multiple gears, however, use of a pair of gears such as gear 32 and receiver gear 54 is preferred. It may be appreciated that the particular gear set 46 may be established to have a rotational output speed which matches an optimal rotational speed of a given accessory device (accessory device not shown). Non-limiting examples of some accessory devices include booster pumps, compressors, foam concentrate pumps, generators or other devices.

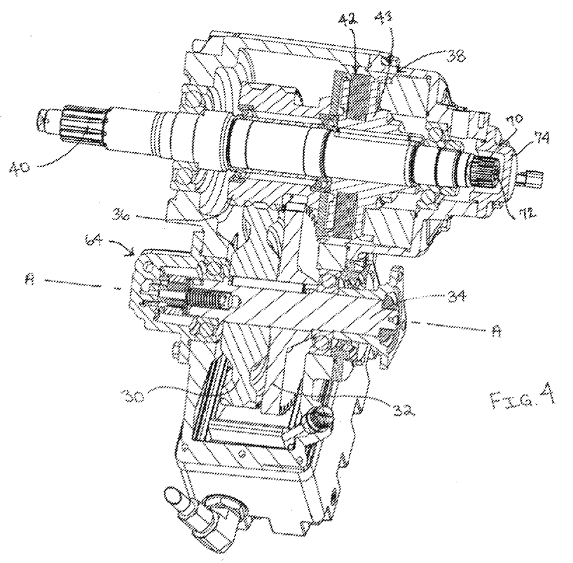

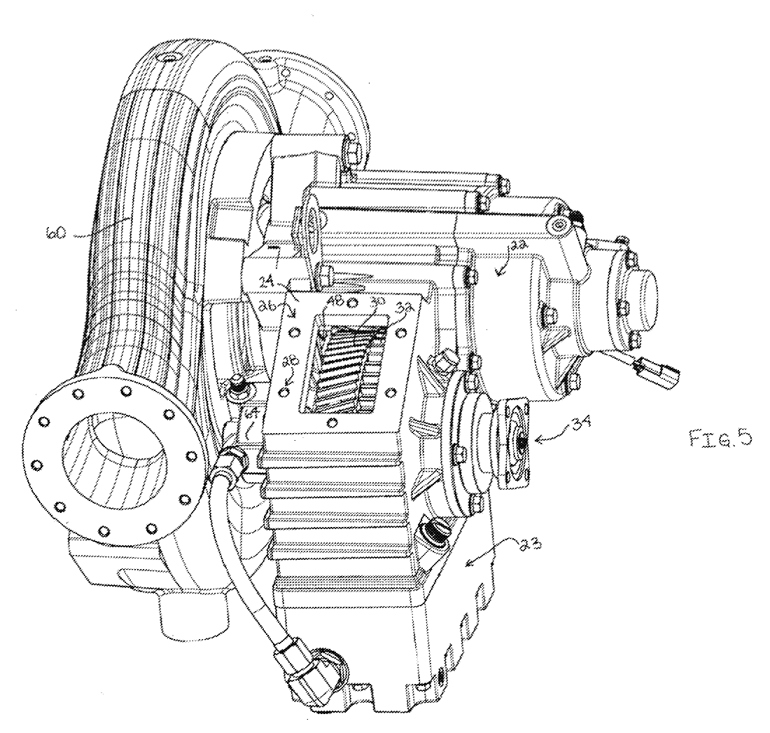

Preferably housing 22 defines a PTO port 48 (See FIG. 5). PTO port 48 allows for access to the inner space of housing 22 where clutch driving gear 30 and PTO gear 32 operate. Preferably port 48 is positioned adjacent clutch driving gear 30 and PTO gear 32. Preferably housing 22 includes a substantially flat mounting face 24. Face 24 is situated on an exterior of housing 22 and preferably about a perimeter 26 of the PTO port 48. Preferably perimeter 26 is dimensioned to match a perimeter 26′ of PTO 50 (See FIG. 8). Preferably mounting face 24 includes at least one bolt hole 28, and more preferably includes at least six bolt holes 28 as shown, and most preferably includes holes or openings having a six or eight bolt pattern as defined under Society of Automotive Engineers Standard SAE J704 or openings having a ten bolt pattern for mounting on an Allison transmission. When PTO device 50 is not mounted to transmission 20, plate 52 is mounted to housing 22 which covers PTO port 48 and clutch driving gear 30 and PTO gear 32. Bolts 29 are used to mount plate 52 to housing 22. While other sizes and varieties are possible, preferably plate 52 is a generally rectangular, planar body which defines and lies on a plane oriented substantially parallel to a longitudinal axis A (see FIG. 4) of drive shaft 34. Preferably mounting face 24 defines a plane oriented substantially parallel to a longitudinal axis A of drive shaft 34. The plane preferably also runs parallel with the gear flanks of the PTO gear 32 (in the case PTO gear is a spur gear). It may be appreciated that where mounting face 24 defines a plane oriented substantially parallel to a longitudinal axis A of drive shaft 34, a mounting of a PTO 50 thereupon provides for a preferred and improved engagement between receiver gear 54 and spur gear 32. Were such orientation not substantially parallel, receiver gear 54 might otherwise be skewed or out of alignment when engaged with gear 32 or when attempting to couple gear 54 and gear 32. Further, port 48 is positioned on a side of transmission 20 as generally shown.

Clutch driving gear 30 and PTO gear 32 may have different diameters and different teeth arrangements. Preferably PTO gear 32 is a spur gear adapted to match with a receiver gear 54 of a PTO 50. Having different gear sets 44, 46 allows for using a common drive shaft 34 to operate impeller 40 while simultaneously (or alternatively) operating PTO 50. It may be appreciated that an accessory device (not shown) such as an air compressor, or a generator, or a secondary pump, or other device, including devices that may be useful on a emergency vehicle such as a fire truck, may be operated from power take-off area 51 (see FIG. 1). It may be appreciated that operation of accessory device is made possible, or at least easier, due to the ability to incorporate a PTO gear set 46 (See FIG. 10) which is different from impeller-clutch gear set 44. Particularly, lower (or higher) spin ratios of a PTO output shaft 56 may be achieved as desired. Advantageously, under the present invention, the respective PTO gearing and impeller shaft gearing may be modified without affecting the ratios of each other. It may be appreciated that additional gear or gears (not shown) may be included within PTO device 50 to accommodate variation of output spin of PTO output shaft 56. Also, a clutch or clutch set (not shown) may be used with or within PTO device 50 to selectively engage or disengage power to an accessory device. In this manner the accessory device may be shut down while powering impeller shaft 40, thus providing further versatility.

Advantageously, use of a Commercially Available PTO device accommodates use of an accessory device to be remotely positioned due to the ability to drive a PTO drive line (drive-line not shown) which may extend outward or away from PTO 50 and housing 22. Drive-line may include a shaft attached to or comprising output shaft 56, and may be equipped with a U-joint or yoke elements, or may include a hydraulic coupling. For instance, an accessory may be generally positioned in the region designated by numeral 62 (or some other region whether on the housing 22 or to a component of a firetruck or other structure). Such orientation allows freedom from having to configure a mounting directly to housing 22, or other relatively close coupling to transmission 20.

The foregoing merely illustrates the principles of the invention. For example, although a multi-disk clutch 38 is mounted to the impeller shaft 40, it may be possible to use other clutch mechanisms to selectively turn “on” clutch 40.

It will thus be appreciated that those skilled in the art will be able to devise numerous alternative arrangements that, while not shown or described herein, embody the principles of the invention and thus are within its spirit and scope.

What is claimed is:

1. A firefighting pump transmission comprising
an impeller clutch driving gear affixed to a drive shaft of said transmission; and
a PTO gear affixed to said drive shaft adjacent said impeller clutch driving gear.

2. The transmission of claim 1 further comprising an impeller shaft having a clutch mounted thereon, said impeller clutch driving gear coupled with said clutch.

3. The transmission of claim 2 where said clutch is a multi-disk clutch.

4. The transmission of claim 1 where said PTO gear is a spur gear.

5. The transmission of claim 1 where said PTO gear abuts said impeller clutch driving gear.

6. The transmission of claim 5 where said clutch includes a clutch gear coupled with said clutch driving gear.

7. The transmission of claim 1 further comprising a PTO device mounted to a housing of said transmission.

8. The transmission of claim 7 where said PTO device is a Commercially Available PTO device.

9. A firefighting pump transmission comprising
a housing,
an impeller shaft;
a PTO gear affixed to a drive shaft within said housing;
an impeller clutch driving gear affixed to said drive shaft and coupled with a multi-disk clutch mounted on said impeller shaft.

10. The transmission of claim 9 further comprising a PTO device mounted on said housing.

11. The transmission of claim 9 further comprising an impeller affixed to said impeller shaft.

12. The transmission of claim 9 further comprising a port defined by said housing, a mounting face positioned about a perimeter of said port and defining a plane, said plane oriented substantially parallel to a longitudinal axis of said drive shaft.
